(19) United States
(12) Patent Application Publication
(10) Pub. No.: US 2003/0101834 A1
(43) Pub. Date: Jun. 5, 2003

(54) Anti-bachlash transmission mechanism

(76) Inventor: Wei-Yu Huang, Taoyuan City (TW)

Correspondence Address: BIRCH STEWART KOLASCH & BIRCH, PO BOX 747, FALLS CHURCH, VA, 22040-0747, US

(21) Appl. No.: 10/062,481

(22) Filed: Feb. 5, 2002

(30) Foreign Application Priority Data
Nov. 30, 2001 (TW) 90220745

(51) Int. Cl. F16H 3/06; F16H 27/02

(52) U.S. Cl. 74/89.42

(57) ABSTRACT

An anti-backlash transmission mechanism that eliminates backlashes is disclosed. An actuator is connected to a transmitted element and a driven gear. The driven gear matches with a driving gear to be receive power transmitted from the driving gear. Through the actuator, the driving gear and the driven gear match tightly in the normal state to eliminate the backlash during positioning. During transmission, the pressure between the driving gear and the driven gear decreases, lowering the friction in between.

### BACKGROUND OF THE INVENTION

1. Field of Invention

The invention relates to a transmission mechanism used in a geared transmission device and, in particular, to a transmission mechanism that can eliminates backlashes.

2. Related Art

Power transmission is commonly seen in usual systems or devices. With the advance in technology, there are higher demands for precision and accurate control in transmission devices. There are many power transmission methods, among which geared transmission best meets current needs. There are many types of geared transmission devices. For example, the combinations of gears, lead screw, match gears, gear racks all require the combinations of gear-type objects to transmit power.

However, a major drawback of the geared transmission devices is the backlash. The backlash refers to the gap between gears. The occurrence of the backlashes may come from manufacturing errors, erosions, and as well as a design for lowering the friction in transmission. Nevertheless, for increasingly precise optical systems, the existence of backlashes results in errors in positioning control and unnecessary vibrations.

For optical disk drive systems, they use screw rods to transmit power from motors. A match gear is connected to the screw rod and moves the optical pickup head. Since it requires fast and precise positioning for the optical pickup head to track, no backlash is allowed. Therefore, the match gear is usually imposed by a predetermined pressure so that the screw rod and the match gear are more tightly connected. However, the match gear imposed with a predetermined pressure increases the friction between the match gear and the screw rod. The transmission thus becomes difficult and the speed is slow for positioning. On the other hand, if the predetermined pressure is too small, then the backlash cannot be effectively eliminated, causing vibrations of the optical pickup head. Such vibration may seriously affect the data picking. In view of these difficulties, there were many solutions proposed in the prior art. Nonetheless, these solutions are either too complicated and difficult or unable to achieve expected effects.

### SUMMARY OF THE INVENTION

The invention thus provides an anti-backlash transmission mechanism. It avoids the occurrence of backlashes and reduces the friction during transmission. The control of the system is also very simple.

According to the disclosed anti-backlash transmission mechanism, it includes a driving gear, a driven gear structure, a driving unit, an actuator, and a controller. The driving gear is connected to the driving unit for receiving the power output from the driving unit. The driven gear structure uses a driven gear to engage with the driving gear. Driven by the driving gear, the driven gear drives its connected device into motion. The actuator is installed inside the driven gear structure and changes the pressure between the driven gear and the driving gear. The controller is used to control the driving unit and the actuator simultaneously.

When the transmission is not in use, the actuator makes the driven gear and the driving gear tightly matched so that the driven gear along with the driven device are accurately fixed. When the transmission mechanism is in use, the controller simultaneously controls the driving unit and the actuator so that the driving unit drives the driving gear into motion. The actuator decreases the pressure between the driving gear and the driven gear, reducing the friction between the driving gear and the driven gear. This structure can eliminate the backlash for positioning and reduce the friction during transmission.

The pressure change between the driving gear and the driven gear is achieved by a minute deformation caused through the action of the actuator. This changes the matching extent between the driving gear and the driven gear. The actuator deforms during its normal state to make both the driving gear and the driven gear closely matched. When the driving unit is in action, the controller restores the actuator, reducing the pressure between the driving gear and the driven gear. Alternatively, one can also make the actuator stay at its original shape in the normal state while deform to reduce the pressure between the driving gear and the driven gear when the driving unit is in action.

### BRIEF DESCRIPTION OF THE DRAWINGS

The invention will become more fully understood from the detailed description given hereinbelow illustration only, and thus are not limitative of the present invention, and wherein:

FIG. 1 is a schematic view of the invention;

FIG. 2 is a schematic view of the controller circuit of FIG. 1; and

FIG. 3 is a schematic view of the controller signal.

### DETAILED DESCRIPTION OF THE INVENTION

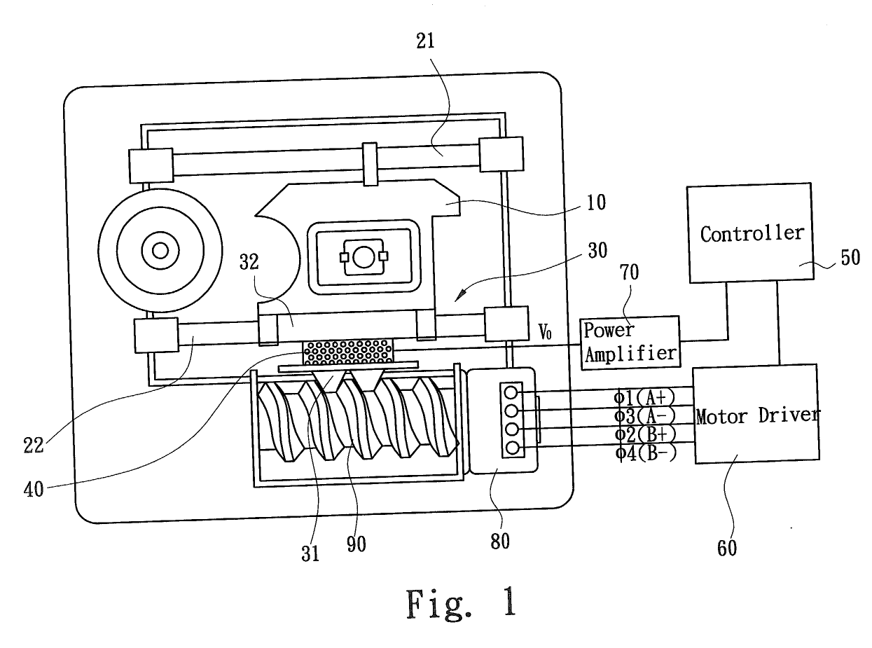

The disclosed anti-backlash transmission mechanism contains a driving gear, a driven gear structure, a driving unit, an actuator, and a controller. An optical disk drive system, an example, has an optical pickup head 10, sliding rods 21, 22, a match gear structure 30, a screw rod 90, a controller 50, a motor driver 60, a power amplifier 70, and a step motor 80 (FIG. 1). The step motor 80 is the driving unit and the screw rod 90 that receives the power from the step motor 80 is the driving gear. The match gear structure 30 connected to the screw rod 90 is the driven gear structure. The optical pickup head 10 is the driven device.

The optical pickup head 10 is installed between the two sliding rods 21, 22 and can slide thereon to track and read or write data on an optical disk. The screw rod 90 is installed on the step motor 80 to receive rotation energy from the step motor 80. The match gear structure 30 uses a match gear to connect to the screw rod 90. It receives the rotation energy from the screw rod 90 to make a linear motion. The actuator 40 can change the pressure between the match gear 31 and the screw rod 90. It is connected to the optical pickup head 10 through a connector 32, thus driving the optical pickup head 10 to slide along the sliding rods 21, 22. The controller 50 uses the motor driver and the power amplifier to control the step motor 80 and the actuator 40.

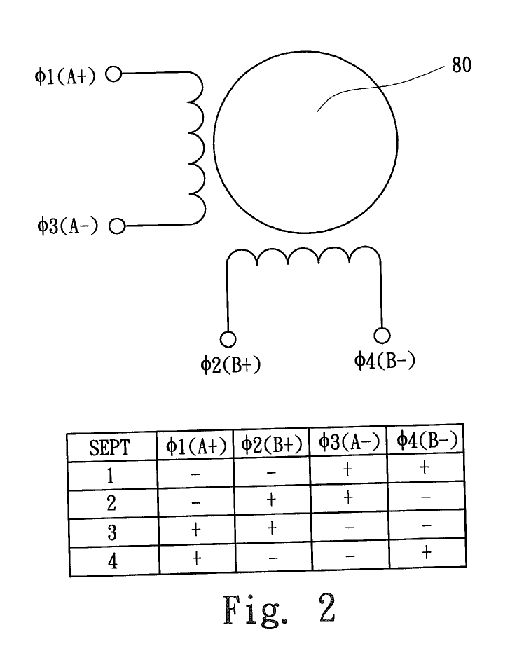

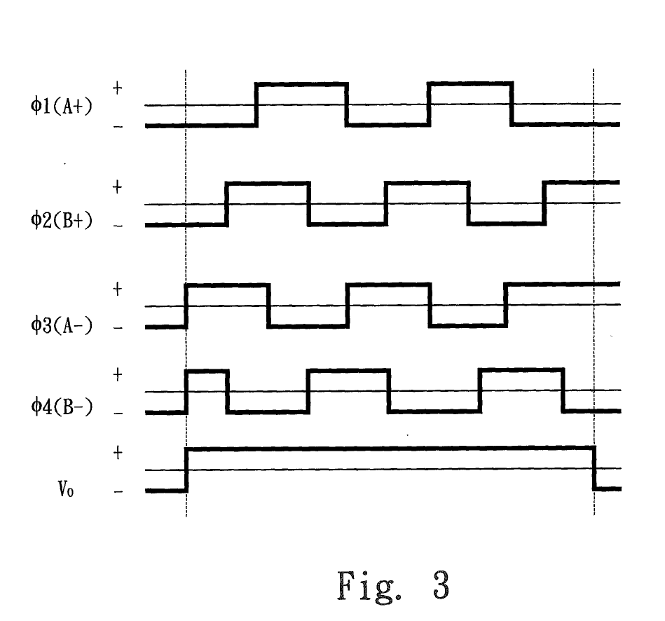

For bipolar step motors 80, the driving method can be one shown in FIG. 2. The controller 50 uses the motor driver 60 to output pulse signals φ1(A+), φ2(B+), φ3(A−), and φ4(B−). The power amplifier 70 produces a driving signal V₀ to drive the actuator 40, as shown in FIG. 3. That is, the controller is used to simultaneously control the step motor 80 and the actuator 40.

In the normal state, the match gear 31 and the screw rod 90 are tightly connected so that the optical pickup head 10 is precisely positioned and fixed to avoid vibrations. When the optical pickup head 10 tracks to read data, the controller 50 simultaneously controls the step motor 80 and the actuator 40. The actuator 40 lowers the pressure between the match gear 31 and the screw rod 90 and thus the friction in between. The step motor 80 brings the screw rod 90 into rotation, so that the match gear 31 makes a linear motion, achieving the tracking effect of the optical pickup head 10. Once the optical pickup head is positioned, the controller 50 also simultaneously controls the step motor 80 and the actuator 40 to restore the pressure and thus the tight connection state between the match gear 31 and the screw rod 90.

The actuator 40 can use an electromagnetic actuator, a piezoelectric actuator, a shape memory alloy, and a thermal deformation double metals. Its minute deformation can change the pressure between the match gear 31 and the screw rod 90. In the normal state, the actuator 40 is kept unchanged. During the transmission, the actuator 40 deforms to lower the pressure between the match gear 31 and the screw rod 90. Alternatively, one can also have the actuator deform in the normal state while stay in its original shape to reduce the pressure between the match gear 31 and screw rod 90.

The optical pickup head 10 can be directly connected to the match gear structure 30 through the actuator 40. In addition, the driven gear and the driving gear are not limited to the match gear 31 and the screw rod 90. They can be any gear-type objects for transmission. For example, they can be gears, screw rods, gear racks, and any gear-type objects that may have backlashes.

### EFFECTS OF THE INVENTION

A transmission mechanism that can eliminate backlashes is herein disclosed. An actuator is used to change the matching extent between the driving gear and the driven gear, i.e. the pressure between the two gears. When the control controller the action of the driving unit, it simultaneously controls the actuator to change the pressure between the driving gear and the driven gear. During transmission, the pressure in between is lowered so that the power transmission is easier and the transmission speed becomes faster. When positioning, the pressure is restored so that the gears are tightly connected and the driven device is fixed. Since the invention utilizes the simple action of the actuator to change the matching extent between the driving gear and the driven gear, the control is thus relatively easy.

What is claimed is:

1. A anti-backlash transmission mechanism to drive a driven device, which comprises:
a driving gear;
a driving unit connected to the driving gear to provide the driving gear power;
a driven gear structure containing at least one driven gear engaging with the driving gear;
an actuator installed on the driven gear structure to change pressure between the driving gear and the driven gear; and
a controller simultaneously controlling the driving unit and the actuator.

2. The anti-backlash transmission mechanism of claim 1, wherein the controller controls actions of the actuator so that the driving gear and the driven gear are tightly connected when the driving unit is in its normal state and the actuator lowers the pressure between the driving gear and the driven gear when the driving unit is in action.

3. The anti-backlash transmission mechanism of claim 1, wherein the controller controls actions of the actuator so that the driving gear and the driven gear are tightly connected when the driving unit is in its normal state and the actuator lowers the pressure between the driving gear and the driven gear when the driving unit is in action.

4. The anti-backlash transmission mechanism of claim 1, wherein the driving gear is a lead screw.

5. The anti-backlash transmission mechanism of claim 1, wherein the driving gear is a gear.

6. The anti-backlash transmission mechanism of claim 1, wherein the driven gear is a screw.

7. The anti-backlash transmission mechanism of claim 1, wherein the actuator is selected from the group consisting of an electromagnetic actuator, a piezoelectric actuator, a shape memory alloy, and a thermal deformation double metals.

8. The anti-backlash transmission mechanism of claim 1, wherein the driven gear structure further comprises a connector to connect the driven device.

9. The anti-backlash transmission mechanism of claim 1, wherein the actuator connects the driven device to the driven gear.
